(19) United States
(12) Patent Application Publication
(10) Pub. No.: US 2011/0107121 A1
(43) Pub. Date: May 5, 2011

(54) POWER SUPPLY AND COMPUTER HAVING EXTERNAL POWER SOURCE

(75) Inventor: Cheng-Yi Lo, Taoyuan Hsien (TW)

(73) Assignee: DELTA ELECTRONICS, INC., Taoyuan Hsien (TW)

(21) Appl. No.: 12/914,411

(22) Filed: Oct. 28, 2010

(30) Foreign Application Priority Data
Oct. 30, 2009 (TW) 098136993

(51) Int. Cl. G06F 1/26

(52) U.S. Cl. 713/300

(57) ABSTRACT

A power supply having an external power source, for receiving a power energy of an input voltage and converting to an external power source and an internal power source which is used in a computer, is disclosed. The power supply includes a body, a power converting module disposed inside the body for receiving the power energy of the input voltage and converting to the external power source and the internal power source, a power input device connected to a power input terminal of the power converting module for transferring the input voltage to the powering converting module, an internal power output device connected to an internal power output terminal of the power converting module and a motherboard of the computer, and an external power output device having one end connected to an external power output terminal of the power converting module and having the other end connected to a computer body of the computer or outside of the body, for transferring the external power source to a portable electronic apparatus.

### FIELD OF THE INVENTION

The present invention relates to a power supply, and more particularly to a power supply having an external power source. The present invention also relates to a computer, and more particularly to a computer having an external power source.

### BACKGROUND OF THE INVENTION

Lately, along with the technology advancement, the electronic products having a variety of functions are developed. It is not only to satisfy humans' various demands but also make humans' life more convenient.

The electronic products are consisted of various electronic elements. However, each electronic element needs to be operated under a proper voltage. Hence, it is necessary to provide a proper voltage to each electronic element by the power supply for keeping the electronic product operate normally. Even the portable electronic products, such as notebook, personal digital assistant (PDA), cellular phone, MP3, are power-provided by battery, their batteries also need to be charged by the power supply (or power adapter). Otherwise, the portable electronic products cannot be operated normally.

However, the portable electronic products have their own power supplies. Hence, for the charging purpose the user must bring various corresponding power supplies when carrying the portable electronic products to go out. It is not only inconvenient but also heavy. Moreover, if the user forgets to bring the corresponding power supply with, the portable electronic product cannot be operated once the battery runs out of power.

For solving the previous problems, it could prepare many the same power supplies at the different places. However, it is costly. Therefore, the purpose of the present invention is to develop a power supply having an external power source and a computer having an external power source to deal with the above situations encountered in the prior art.

### SUMMARY OF THE INVENTION

An object of the present invention is to provide a power supply having an external power source for continuously providing an external power source no matter that the operation status of the computer including the power supply having the external power source is “ON” or “OFF”.

Another object of the present invention is to provide a computer having an external power source for continuously providing an external power source no matter that the operation status of the computer having the external power source is “ON” or “OFF”.

An additional object of the present invention is to provide a power supply having an external power source for easily and conveniently to provide an external power source to a portable electronic apparatus.

An additional object of the present invention is to provide a computer having an external power source for easily and conveniently to provide an external power source to a portable electronic apparatus.

According to an aspect of the present invention, there is provided a power supply having an external power source for receiving a power energy of an input voltage and converting to an external power source and an internal power source which is used in a computer. The power supply includes a body, a power converting module disposed inside the body for receiving the power energy of the input voltage and converting to the external power source and the internal power source, a power input device connected to a power input terminal of the power converting module for transferring the input voltage to the powering converting module, an internal power output device connected to an internal power output terminal of the power converting module and a motherboard of the computer, and an external power output device having one end connected to an external power output terminal of the power converting module and having the other end connected to a computer body of the computer or outside of the body of the power supply, for transferring the external power source to a portable electronic apparatus.

According to another aspect of the present invention, there is provided a computer having an external power source for providing an external power. The computer includes a computer body, a motherboard disposed inside the computer body, a memory device for storing programs and information, and a power supply having an external power source disposed inside the computer body for receiving a power energy of an input voltage and converting to an external power source and an internal power source. The power supply includes a body, a power converting module disposed inside the body for receiving the power energy of the input voltage and converting to the external power source and the internal power source, a power input device connected to a power input terminal of the power converting module for transferring the input voltage to the powering converting module, an internal power output device connected to an internal power output terminal of the power converting module and the motherboard for transferring the internal power source to the motherboard, and an external power output device having one end connected to the external power output terminal of the power converting module and having the other end connected to the computer body or outside of the body of the power supply, for transferring the external power source to a portable electronic apparatus.

### BRIEF DESCRIPTION OF THE DRAWINGS

The present invention may best be understood through the following description with reference to the accompanying drawings, in which:

FIG. 1 is a diagram illustrating a preferred embodiment of a power supply having an external power source according to the present invention;

FIG. 2 is a diagram illustrating a preferred embodiment of a computer having an external power source according to the present invention;

FIG. 3 is a circuit diagram illustrating a preferred embodiment of a power converting module according to the present invention;

FIG. 4 is a circuit diagram illustrating another preferred embodiment of a power converting module according to the present invention; and

FIG. 5 is a circuit diagram illustrating a further preferred embodiment of a power converting module according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

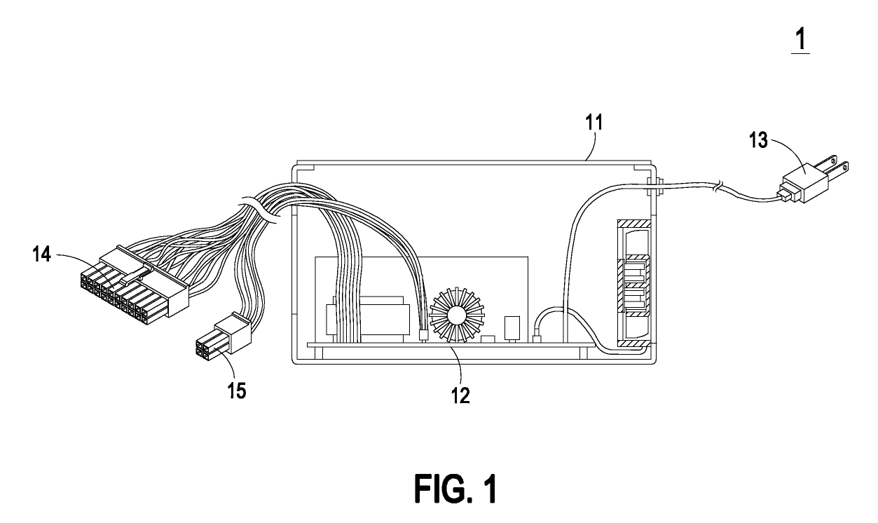

FIG. 1 is a diagram illustrating a preferred embodiment of a power supply having an external power source according to the present invention. As shown in FIG. 1, a power supply 1 having an external power source includes a body 11, a power converting module 12, a power input device 13, an internal power output device 14 and an external power output device 15. The power converting module 12 is disposed inside the body 11 for receiving the energy of an input voltage and converting to an external power source and an internal power source provided to a computer. The power input device 13 is connected to the power input terminal of the power converting module 12 for transferring input voltage to the power converting module 12. The internal power output device 14 is connected to the internal power output terminal of the power converting module 12 and a motherboard of a computer (not shown in FIG. 1) for transferring an internal power source which generated from the power converting module 12 to the motherboard of the computer. Furthermore, one end of the external power output device 15 is connected to a computer body (not shown in FIG. 1) or outside of the body 11 for transferring an external power source to a portable electronic product (not shown in FIG. 1).

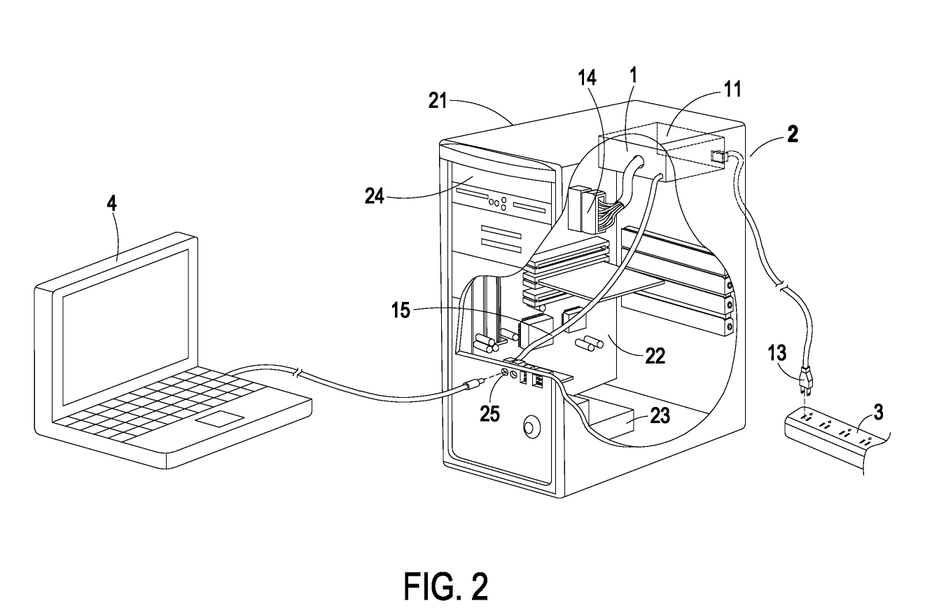

Please refer to FIGS. 2 and 1. FIG. 2 is a diagram illustrating a preferred embodiment of a computer having an external power source according to the present invention. As shown in FIG. 2, a computer 2 having an external power source includes the power supply 1 with the external power source, a computer body 21, a motherboard 22, a hard disc 23 and a CD-ROM drive 24. The power supply 1, the motherboard 22, the hard disc 23 and the CD-ROM drive 24 are disposed inside the computer body 21, respectively. Furthermore, the power input device 13, the internal power output device 14 and the external power output device 15 of the power supply 1 are connected to a power supply device 3, the motherboard 22 and an external power connector 25 of the computer body 21, respectively.

An input voltage provided by the power supply device 3 is transferred to the power converting module 12 of the body 11 (as shown in FIG. 1) via the power input device 13. Subsequently, the input voltage is converted into the external power source and the internal power source by the power converting module 12. The internal power source is transferred to the motherboard 22 via the internal power output device 14, and the external power source is transferred to the external power connector 25 outside the computer body 21 via the external power output device 15. Hence, the user can directly connect a portable electronic apparatus 4 to the external power output device 15 via the external power connector 25. Then, the external power source can be provided to the portable electronic apparatus 4 to not only keep it operating normally but also charge its battery.

When the user turns on the computer 2 with the external power source, a power control signal of “ON” status is issued from the motherboard 22 to the power supply 1 to start outputting the internal power source from the power supply 1 to the motherboard 22. After receiving the internal power source, the motherboard 22 reads and executes the operating system program stored in the memory device, such as the hard disc 23 or the CD-ROM drive 24, to complete the turn-on procedure of the computer 2. On the other hand, when the user turns off the computer 2 with the external power source, a power control signal of “OFF” status is issued from the motherboard 22 to the power supply 1 to stop the power supply 1 outputting the internal power source to the motherboard 22. Hence, whether the internal power source is provided or not is dependent on the operation status of the computer 2. However, no matter the status of the computer 2 is “ON” or “OFF”, the power supply 1 will continue to provide the external power source. That is, that the external power is continuously provided by the power supply 1 with the external power source will not be stopped because of the operation status of the computer 2. Therefore, the portable electronic apparatus 4 can be connected to the external power connector 25 and the external power output device 15 to receive the external power source when the computer 2 is turned off besides the computer 2 is turned on, for maintaining normal operation or continuously charging the battery.

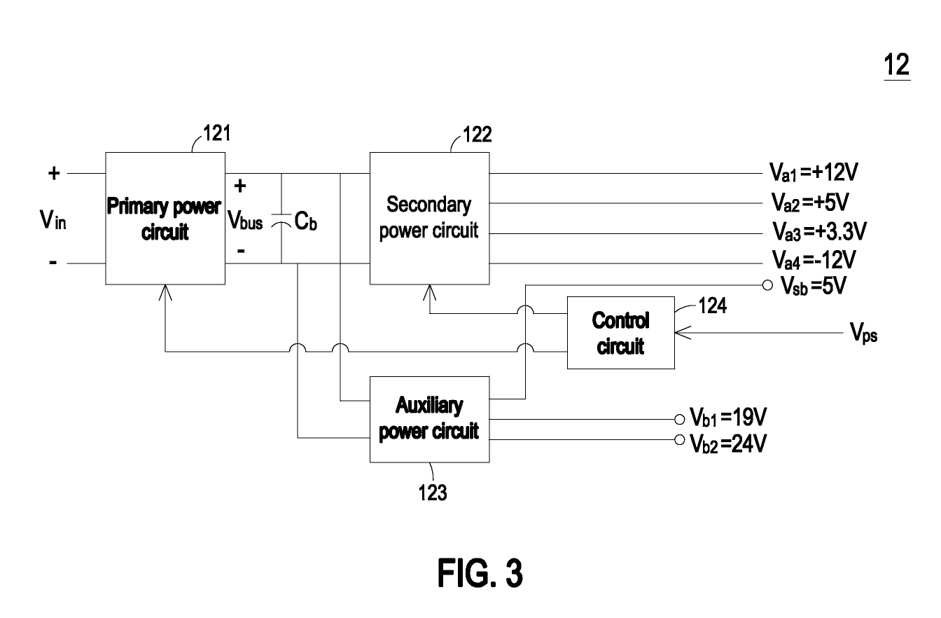

Please refer to FIGS. 2 and 3. FIG. 3 is a circuit diagram illustrating a preferred embodiment of a power converting module according to the present invention. As shown in FIG. 3, the power converting module 12 includes a primary power circuit 121, a secondary power circuit 122, an auxiliary power circuit 123, a control circuit 124, and a busbar capacitor C_{b}. The input terminal of the primary power circuit 121 is the input terminal of the power converting module 12 for receiving an input voltage V. The output terminal of the primary power circuit 121 is connected to the busbar capacitor C_{b}. Furthermore, the input terminals of the secondary power circuit 122 and the auxiliary power circuit 123 are connected to the busbar capacitor C_{b}. The control circuit 124 is connected to the primary and secondary power circuits 121 and 122 for respectively controlling the operations of the primary and secondary power circuits 121 and 122.

In this preferred embodiment, the internal power source includes a first internal voltage Vₐ₁, a second internal voltage Vₐ₂, a third internal voltage Vₐ₃ and a fourth internal voltage Vₐ₄ outputted by the secondary power circuit 122 and a standby voltage V_{sb} outputted by the auxiliary power circuit 123. The external power source includes a first external voltage V_{b1} and a second external voltage V_{b2}. Therefore, the internal power output terminal of the power converting module 12 includes all output terminals of the secondary power circuit 122 and the standby output terminal of the auxiliary power circuit 123 while the external power output terminal of the power converting module 12 includes the first and second external output terminals.

In this preferred embodiment, the rated voltages of the first, second, third and fourth internal voltages Vₐ₁, Vₐ₂, Vₐ₃, and Vₐ₄, the standby voltage V_{sb}, and the first and second external V_{b1} and V_{b2} are, for example, +12V, +5V, +3.3V, −12V, +5V, +19V and +24V, respectively.

Please refer to FIG. 3. When the user turns on the computer 2 having the external power source, a power control signal Vₚₛ with “ON” status is issued by the motherboard 22 to the control circuit 124 for allowing the control circuit 124 to respectively control the operations of the primary and secondary power circuits 121 and 122. At the meantime, the input voltage Vᵢₙ is rectified and filtered by the primary power circuit 121 to generate a busbar voltage V_{bus} to the input terminals of the secondary power circuit 122 and the auxiliary power circuit 123. After receiving the power energy of the busbar voltage V_{bus}, the secondary power circuit 122 generates the first, second, third and fourth internal voltages Vₐ₁, Vₐ₂, Vₐ₃, and Vₐ₄, respectively. Similarly, the auxiliary power circuit 123 receives the power energy of the busbar voltage V_{bus} to generate the standby voltage V_{sb}, and the first and second external V_{b1} and V_{b2}, respectively. On the other hand, when the user turns off the computer 2 having the external power source, the power control signal Vₚₛ with “OFF” status is issued by the motherboard 22 to the control circuit 124. Subsequently, the secondary power circuit 122 is controlled by the control circuit 124 to stop outputting the first, second, third and fourth internal voltages Vₐ₁, Vₐ₂, Vₐ₃, and Vₐ₄ in respond to the power control signal Vₚₛ with “OFF” status. However, the auxiliary power circuit 123 keeps outputting the first and second external V_{b1} and V_{b2}, no matter that the power control signal Vₚₛ is “ON” or “OFF”.

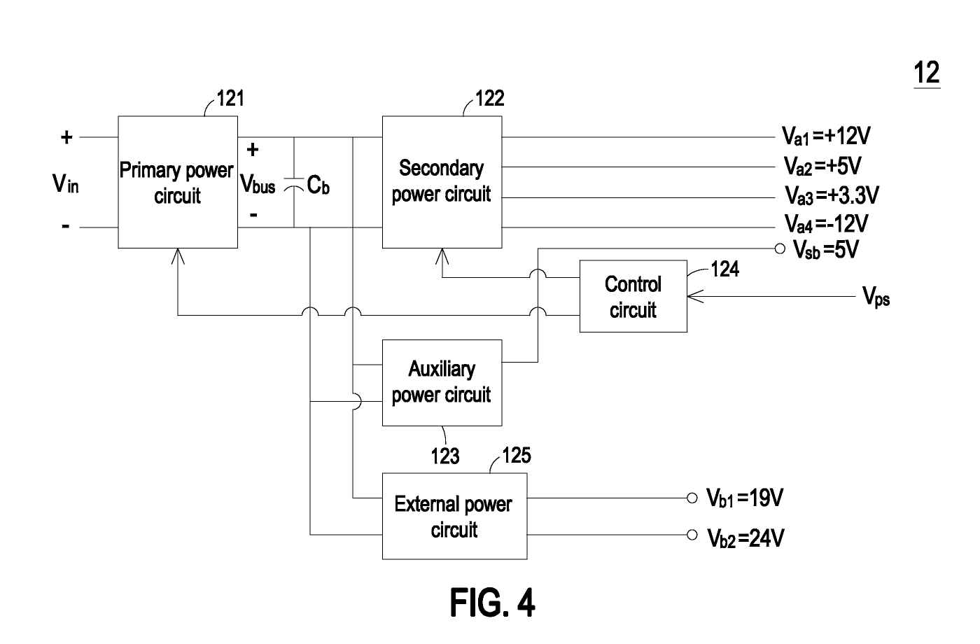

FIG. 4 is a circuit diagram illustrating another preferred embodiment of a power converting module according to the present invention. Please refer to FIGS. 2, 3 and 4. The circuits of FIG. 3 and FIG. 4 are similar except that the power converting module 12 of FIG. 4 further includes an external power circuit 125 and the first and second external V_{b1} and V_{b2} are generated by the external power circuit 125. The input terminal of the external power circuit 125 is connected to the busbar capacitor C_{b}. Furthermore, the external power circuit 125 continues to receive the power energy of the busbar voltage V_{bus} to respectively generate the first and second external V_{b1} and V_{b2} no matter that the power control signal Vₚₛ is “ON” or “OFF”.

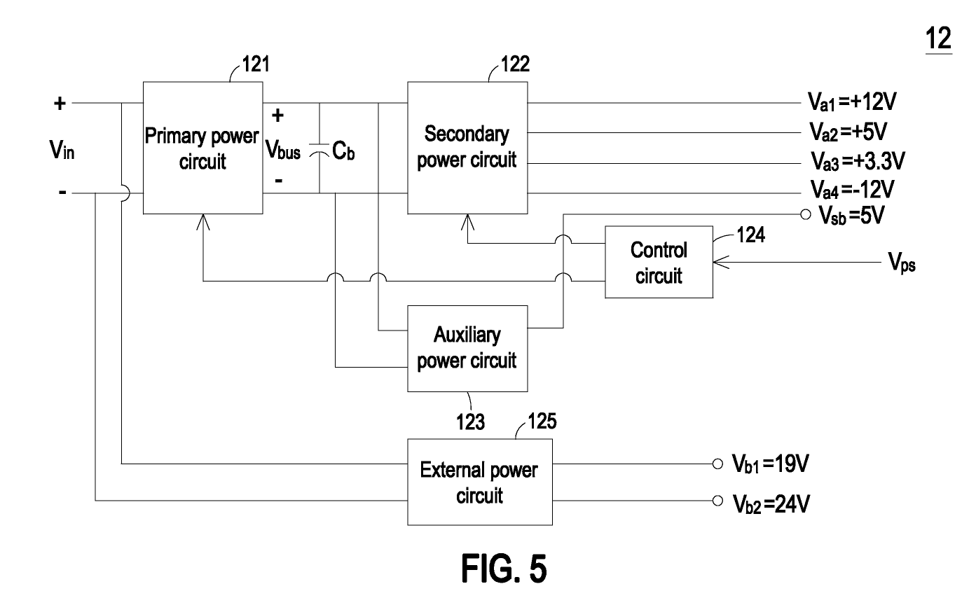

FIG. 5 is a circuit diagram illustrating a further preferred embodiment of a power converting module according to the present invention. Please refer to FIGS. 2, 4 and 5. The differences between FIGS. 4 and 5 are that the input terminal of the power converting module 12 is connected to the input terminal of the primary power circuit 121, and the external power circuit 125 directly receives the power energy of the input voltage Vᵢₙ to output the first and second external V_{b1} and V_{b2}, respectively.

In this preferred embodiment, the primary power circuit 121 further has the power factor correction (PFC) function for efficiently improving the problem that the power factor is too low. In addition, the internal power source is provided to hard disc 23 and CD-ROM drive 24 besides the motherboard 22. In some preferred embodiments, the external power output device 15 is disposed in the external power output connector (not shown) outside of the body 11 of the power supply. Once the portable electronic apparatus 4 is connected to the external power output connector, the external power source can be transferred to the portable electronic apparatus 4 via the external power output connector.

To sum up, no matter that the status of the computer having the external power source is “ON” or “OFF”, the computer or the power supply having the external power source according to the present invention can continue to provide an additional external power source. The user can connect the portable electronic apparatus to the external power connector outside of the computer body to receive the external power source from the external power output device, for keeping the portable electronic apparatus operating normally or charging the battery of the portable electronic apparatus. Hence, it is not necessary to carry the power supply of the portable electronic apparatus therewith. Furthermore, since the personal computer is very popular and almost everywhere in our life, the user can easily reach the computer to charge the battery of the portable electronic apparatus or use the external power source to keep the normal operation of the portable electronic apparatus if the computer having the external power source. Moreover, the user also can save money because it is not necessary to buy many power supplies or power adapters with the same specification to put at different places. Thus, comparing to the conventional computer or power supply, the computer and the power supply having the external power source according to the present invention includes many advantages which can not be achieved by the prior art.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A power supply having an external power source for receiving a power energy of an input voltage and converting to an external power source and an internal power source which is used in a computer, comprising:
a body;
a power converting module disposed inside said body for receiving said power energy of said input voltage and converting to said external power source and said internal power source;
a power input device connected to a power input terminal of said power converting module for transferring said input voltage to said powering converting module;
an internal power output device connected to an internal power output terminal of said power converting module and a motherboard of said computer; and
an external power output device having one end connected to an external power output terminal of said power converting module and having the other end connected to a computer body of said computer or outside of said body, for transferring said external power source to a portable electronic apparatus.

2. The power supply according to claim 1 wherein said power converting module is controlled by a power control signal of said motherboard to stop or start providing said internal power source.

3. The power supply according to claim 2 wherein when said motherboard issues said power control signal of an “ON” status to said power converting module, said power converting module outputs said internal power source to said motherboard.

4. The power supply according to claim 2 wherein when said motherboard issues said power control signal of an “OFF” status to said power converting module, said power converting module stops outputting said internal power source to said motherboard.

5. The power supply according to claim 2 wherein said power converting module keeps providing said external power source no matter said power control signal is in “ON” or “OFF” status.

6. The power supply according to claim 2 wherein said power converting module comprises:
a primary power circuit having an input terminal, which is said input terminal of said power converting module, for rectifying and filtering said input voltage to generate a busbar voltage;
a busbar capacitor connected to said input terminal of said primary power circuit;
a secondary power circuit having an input terminal, which is connected to said busbar capacitor, for receiving a power energy of said busbar voltage to generate a plural of internal voltages to said internal power output terminal of said power converting module;
an auxiliary power circuit having an input terminal, which is connected to said busbar capacitor, for receiving a power energy of said busbar voltage to generate a standby voltage; and
a control circuit connected to said primary power circuit and said secondary power circuit, for responding to said power control signal to control said power converting module.

7. The power supply according to claim 6 wherein said auxiliary power circuit further provides a first external voltage or said power converting module further comprises an external power circuit for generating said first external voltage.

8. The power supply according to claim 7 wherein an input terminal of said external power circuit is connected to said input terminal of power converting module or said busbar capacitor.

9. The power supply according to claim 7 wherein said internal power source comprises said standby voltage and said plural internal voltages.

10. The power supply according to claim 7 wherein said external power source comprises said first external voltage.

11. A computer having an external power source for providing an external power, comprising:
a computer body;
a motherboard disposed inside said computer body;
a memory device for storing programs and information; and
a power supply having an external power source disposed inside said computer body for receiving a power energy of an input voltage and converting to an external power source and an internal power source, said power supply comprising:
a body;
a power converting module disposed inside said body for receiving said power energy of said input voltage and converting to said external power source and said internal power source;
a power input device connected to a power input terminal of said power converting module for transferring said input voltage to said powering converting module;
an internal power output device connected to an internal power output terminal of said power converting module and said motherboard for transferring said internal power source to said motherboard; and
an external power output device having one end connected to said external power output terminal of said power converting module and having the other end connected to said computer body or outside of said body, for transferring said external power source to a portable electronic apparatus.

12. The computer according to claim 11 wherein said power converting module is controlled by a power control signal of said motherboard to stop or start providing said internal power source.

13. The computer according to claim 12 wherein when said motherboard issues said power control signal of an ON status to said power converting module, said power converting module outputs said internal power source to said motherboard.

14. The computer according to claim 12 wherein when said motherboard issues said power control signal of an OFF status to said power converting module, said power converting module stops outputting said internal power source to said motherboard.

15. The computer according to claim 12 wherein said power converting module keeps providing external power source no matter said power control signal is in ON or OFF status.

16. The computer according to claim 12 wherein said power converting module comprises:
a primary power circuit having an input terminal, which is said input terminal of said power converting module, for rectifying and filtering said input voltage to generate a busbar voltage;
a busbar capacitor connected to said input terminal of said primary power circuit;
a secondary power circuit having an input terminal, which is connected to said busbar capacitor, for receiving a power energy of said busbar voltage to generate a plural of internal voltages to said internal power output terminal of said power converting module;
an auxiliary power circuit having an input terminal, which is connected to said busbar capacitor, for receiving a power energy of said busbar voltage to generate a standby voltage; and
a control circuit connected to said primary power circuit and said secondary power circuit, for responding to said power control signal to control said power converting module.

17. The computer according to claim 16 wherein said auxiliary power circuit further provides a first external voltage or said power converting module further comprises an external power circuit for generating said first external voltage.

18. The computer according to claim 17 wherein an input terminal of said external power circuit is connected to said input terminal of power converting module or said busbar capacitor.

19. The computer according to claim 17 wherein said internal power source comprises said standby voltage and said plural internal voltages.

20. The computer according to claim 17 wherein said external power source comprises said first external voltage.
